(19) United States
(12) Patent Application Publication
(10) Pub. No.: US 2026/0119214 A1
(43) Pub. Date: Apr. 30, 2026

(54) VISUAL ASSIST AT USER FRUSTRATION POINT THROUGH EYE TRACKING

(71) Applicant: Dell Products L.P., Round Rock, TX (US)

(72) Inventors: MING QIAN, Allston, MA (US); HANNAH CLAIRE HYATT, Seattle, WA (US); HANNA YEHUDA, Acton, MA (US); JOANNE HUBBARD, Concord, MA (US)

(21) Appl. No.: 18/931,530

(22) Filed: Oct. 30, 2024

(51) Int. Cl. G06F 9/451; G06F 3/01

(52) U.S. Cl. CPC G06F 9/453; G06F 3/013

(57) ABSTRACT

Methods and systems for managing operation of a data processing system are disclosed. To manage operation of the data processing system, activity of a user of the data processing system may be monitored. The monitored activity may be used to identify a cognitive load on the user when performing a workflow. If the cognitive lead exceeds a threshold level, then the data processing system may dynamically modify its operations to reduce the cognitive load on the user.

### FIELD

Embodiments disclosed herein relate generally to managing a data processing system. More particularly, embodiments disclosed herein relate to systems and methods for managing operation of data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2D show diagrams illustrating data flows in accordance with an embodiment.

FIGS. 2E-2H show diagrams illustrating a examples of interactions between a user and user interface elements presented to the user by the data processing system in accordance with an embodiment.

FIG. 3 shows a flow diagram illustrating a method of managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing (operation of) data processing systems. The data processing systems may provide computer implemented services to users of the data processing systems. The computer implemented services may include any quantity and type of such services. To provide the computer implemented services, data processing systems may include any number of hardware components (e.g., processors, memory modules, storage devices, communication device, etc.). The hardware components may support execution of any number and types of application (e.g., software components).

To provide the computer implemented services, user feedback may be obtained. For example, a user may provide user input by interacting with the data processing system via a graphical user interface (e.g., screen, display, etc.). To facilitate the interaction (e.g., between the user and the data processing system), various user interface elements (e.g., dashboards, menus and other widgets) may be displayed to the user via the graphical user interface. By displaying the user interface elements, the user may activate various functions of software components by navigating the user interface elements (e.g., widget functions and other components using graphical user interfaces) to complete a desired workflow.

However, if the user is unable to navigate the graphical user interfaces in a manner required to activate the function of the software components (e.g., intended use of the software components) then the function may not be activated and therefore, computer implemented services may not be provided and/or provided in an effective manner.

For example, the user may select certain widgets (e.g., shown on a display hosted by the data processing system) as part of performing a task (e.g., one of the functions of the software). If the user is unable to locate the widgets (e.g., due to poor design and/or presentation of the widgets) and/or if the selection of widgets necessary to complete the task is complicated, the user may be deterred from engaging in further interactions with the user interface, and therefore, decrease the likelihood of the completion of the task and the desired computer implemented services may not be provided.

To understand the interactions between a user and user interface elements, a recording of content displayed on a graphical user interface (e.g., screen, monitor, etc.) may be obtained and used to identify challenges faced by a user when interacting with user interface elements. However, the content (e.g., data) shown on the graphical user interface may include sensitive data and as such, obtaining a copy (e.g., recording) of the content may violate privacy considerations of the user and/or require obtaining additional approval from the user in order to adhere to privacy regulations.

Even if lack of access to data (e.g., screen recording data) was resolved, the system may lack sufficient resources and/or consume large quantities of limited resources in order to analyze the data to identify challenges presented to a user during interactions between user interface elements.

Thus, to manage operation of a data processing system, user flow data sets indicating a set of interactions during each performance of a monitored workflow may be obtained and analyzed to identify metadata for each user flow data set usable to order the user flow data sets. The metadata may include various quantifications of the set of interactions that impact performance of the workflow from being completed in a timely, desirable manner by the user (e.g., of the data processing system). By doing so, a system in accordance with an embodiment may provide insights to identifying modifications and/or updates addressing challenges impacting user interactions with user interface elements (e.g., hosted by a display of a data processing system). Accordingly, the system may update operation of the data processing system based on the identified modifications and/or updates in order to provide improved computer implemented services.

The user flow data sets may be used to (i) update graphical user interfaces to improve the ability of users to perform workflows, and (ii) dynamically adjust operation of the data processing system to manage cognitive burdens on users performing workflows. For example, the data processing systems may monitor cognitive load on the user, and user the user flow data to infer a workload that the user is likely to be performing. If the cognitive load exceeds a threshold level, then the data processing system may identify a next action in an inferred workflow and assist the user in completing the next action. The data processing system may assist the user by providing visual and/or multisensory cues to the user. By doing so, the data processing system may reduce the cognitive load on the user to perform workflows.

Accordingly, embodiments disclosed here may address, in addition to other technical problems, the technical problem of cognitive burden in use of data processing systems. The disclosed embodiments may do so by monitoring cognitive load of the user and dynamically adjusting operation of the data processing system to address excessive levels of cognitive burden.

In an embodiment, a method for managing operation of a data processing system is provided. The method may include monitoring user input by a user and visual gaze of the user on at least one user interface presented by the data processing system to the user; in an instance of the monitoring where the user input and/or the visual gaze indicates that a level of cognitive load on the user has exceeded a threshold level: identifying, based on the user input and the visual gaze, a next action in an inferred workflow believed to be being performed by the user; and updating, based on the next action, the at least one user interface to direct future activity of the user.

The method may also include identifying, based on the user input and the visual gaze, the inferred workflow from a plurality of inferred workflows.

Each of the plurality of inferred workflows may be based on attention of a user during previous performances of the inferred workflows.

The attention of the user may be based on, at least, second user input by the user and second visual gaze of the user during the previous performances of the inferred workflows.

Each of the inferred workflows may be an instance of previously performance instances of a monitored workflow that is deemed to be a best workflow.

The best workflow may be a shortest workflow.

The method may also include, obtaining feedback from the user regarding an update made to the user interface during the updating; and using the feedback to update a manner in which future inferred workloads are identified.

The method may additionally include estimating the level of cognitive load based on loops, reversions, and/or other aspects of a visual gaze path indicated by the visual gaze over time.

The method may further include monitoring the future activity of the user; making an identification regarding whether the future activity indicates that the inferred workflow is an actual workflow being performed by the user; and using the identification to update a manner in which future inferred workloads are identified.

The inferred workflow may be a remediation workflow for resolving a root cause of an issue impacting operation of the data processing system.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

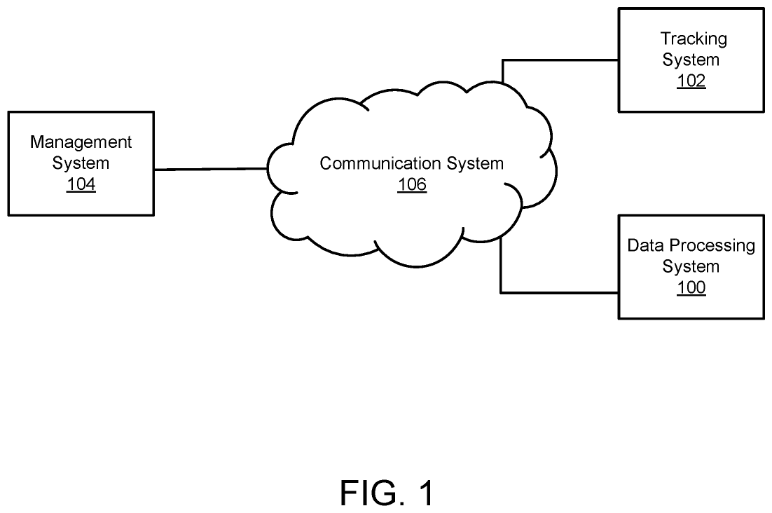

Turning to FIG. 1, a block diagram illustrating a system in accordance with an embodiment is shown. The system shown in FIG. 1 may provide computer-implemented services. The computer-implemented services may include data management services, data storage services, data access and control services, database services, and/or any other type of service that may be implemented with a computing device.

The system may include data processing system 100. Data processing system 100 may provide all, or a portion, of the computer implemented services. To provide the computer implemented services, workloads may be performed by various components of data processing system 100. To perform the workloads, user input may need to be obtained. The user input may include any type and quantity of information.

To obtain user input, a user may interact with at least one graphical user interface hosted by data processing system 100. For example, a user may perform physical actions such as, for example, pressing buttons on a keyboard, moving structures (e.g., such as a computer mouse), etc. To facilitate the interaction between a user and data processing system 100, various user interface elements may be presented to the user via the graphical user interface of data processing system 100. For example, the user interface elements may include menus, widgets, and/or other types of user interface elements shown on a display of data processing system 100.

To provide the input, the user may need to navigate the user interface elements (e.g., widgets, menus, etc.) and/or other elements presented on the graphical user interface of data processing system 100 in order to activate various functions of software components of the data processing system and thereby perform the desired workflow. However, if the user is unable to navigate the graphical user interfaces in a manner required to activate the function (e.g., of the software components), the function may not be activated and therefore, the computer implemented services may not be provided and/or provided in a desirable manner.

To identify potential issues, challenges, and/or other hinderances that the user may experience when navigating the graphical user interface to complete various workflows, a user's interactions with the user interface elements (e.g., presented by data processing system 100) may be tracked in order. To do so, data processing system 100 may host hardware and/or software components that obtain signals and/or data representing eye gaze of a user (e.g., operating data processing system 100). For example, a camera lens and sensor hosted by data processing system 100 may record locations of where the user (e.g., while operating data processing system 100) is visually looking on the display of data processing system 100. The recorded locations of where the user was visually looking at may be represented by a pixel range (e.g., range of pixels displayed by data processing system 100).

A video of the screen (e.g., information displayed to the user at the time of operation) may be recorded and used, in addition to the visual tracking data, to identify the user's interactions with the user interface elements. However, video recordings of information displayed to the user may present a problem regarding violation of privacy regulations and/or additional challenge to obtain authorization from the user to record the information prior to execution. For example, obtaining approval from the user's to record content displayed by data processing system 100 may present a challenge if the content includes sensitive data such as privileged and/or proprietary information and unauthorized disclosure of such data may be disadvantageous to the user.

Even if authorization to obtain a screen recording of the content displayed to a user was granted, the screen recording data may implicate privacy considerations and/or consume large quantities of storage space (e.g., of storage devices hosted by data processing system 100) as well as require a subject matter expert to review the screen recording data to identify potential challenges, issues, errors, etc. with the user interface elements in order to generate modifications to the operation of the data processing system 100 to improve usability of data processing system 100.

For example, screen recording data along with eye tracking data may consume large quantities of storage space in addition to consuming large amounts of processing power (e.g., processor capabilities) in order to be stored and/or analyzed for identification of design challenges and/or modifications to various graphical user interfaces used in performance of various workflows. If the challenges impacting user's interactions with the graphical user interfaces are not identified, the workflows may not be performed in a desirable manner and then the system may fail to provide the desired computer implemented services. For example, complex user interface designs may reduce a user's ability to easily perform a workflow which may cause a delay in performing the workflow leading to the resulting services (e.g., outcome of the workflow) not being provided in a timely manner.

Further, even is updated based on such data, the graphical user interfaces may still present challenges for users to navigate.

In general, embodiments disclosed herein may provide methods, systems, and/or devices for managing operation of a data processing system. To manage operation of the data processing system, a system in accordance with an embodiment may analyze sets of interactions (e.g., user flow data sets) between a user (of the data processing system) and user interface elements (presented to the user by the data processing system) during performance of the various monitored workflows in order to (i) identify and seamlessly implement updates to operation of the data processing system, and (ii) dynamically assist the user in use of the data processing system.

To update operation of the data processing system, the system may analyze the user flow data sets to obtain metadata usable to order the user flow data sets. The metadata may be used to estimate a user time cost for each of the user flow data sets and the estimated user time cost for each of the user flow data sets may be used to order the user flow data sets from lowest user time cost to the highest user time cost.

By doing so, quantifications leading to increased duration of time to complete the monitored workflow in a prescribed manner by the user may be identified based on the ordering of the user flow data sets and may be leveraged to update and optimize the user interface (e.g., design of the user interface, user interface elements, etc.), thereby streamlining workflows, improving the likelihood of a user's experience (e.g., operating the data processing system), and/or increasing the likelihood of the data processing system providing the desirable computer implemented services to the user.

In addition to enabling workflows to be streamlined, the user flow data sets in combination with additional tracking may enable the data processing systems to (i) infer workflows being performed by users, (ii) identify whether users are having difficulty performing the workflows (e.g., due to graphical user interface layout), and (iii) guide the user in performance of the workflows when such difficulties are encountered. By doing so, the cognitive burden on users may be reduced when performing workflows, which may be complex and require use of multiple user interfaces.

To provide the above noted functionality, the system of FIG. 1 may include data processing system 100, tracking system 102, management system 104, and communication system 106. Data processing system 100, tracking system 102, management system 104, and/or any other type of devices not shown in FIG. 1 may perform all, or a portion of the computer-implemented services independently and/or cooperatively. Each of these components is discussed below.

Data processing system 100 may (i) facilitate collection of data, (ii) identify the type of data collected, (iii) provide the data to external entities (e.g., tracking system 102, management system 104, etc.), (iv) receive information including instructions for updating operation of the data processing system, and/or (v) otherwise facilitate collection, transmission, and/or management of data regarding interactions between user interface elements and a user (operating data processing system 100).

Data processing system 100 may include hardware components usable to provide the computer implemented services. For example, data processing system 100 may be implemented using a computing device such as a laptop computer, desktop computer, portable computer, and/or other types of computing devices. Data processing system 100 may include devices which may collect, store, and/or manage data, various types of sensors connected to a computer that collects information (e.g., camera, microphone, etc.), and/or any other type of data collection devices.

Data processing system 100 may host software that may use user input to provide the computer implemented services. For example, the software may provide user input fields and/or other elements through which the user may provide information to manage and/or use the computer implemented services provided by data processing system 100. For example, the user may physically interact with data processing system 100 (and/or component thereof), thereby allowing signals and/or data to include information regarding the physical actions of the user.

For example, if a user actuates a moveable structure (e.g., buttons) of a human interface device (of data processing system 100), data processing system 100 may track the actuation of the button and provide signals and/or data reflecting the actuation (e.g., the user input).

To facilitate computer implemented services, tracking system 102 may (i) obtain user flow data sets for a plurality of instances of performance of a monitored workflow, (ii) obtain metadata for each user flow data set, and the metadata may include at least one quantification usable to order the user flow data sets (e.g., with respect to goals), (iii) obtain an ordering of the user flow data sets using the metadata and the user flow data sets, (iv) update operation of the data processing system (e.g., 100) to obtain an updated data processing system using at least the ordering, (v) monitor use of user interface by the users to identify cognitive load, (vi) when cognitive loads exceed prescribed level automatically intervene to reduce the cognitive loads, and/or (vii) otherwise facilitate collection, transmission, and/or analysis of data usable for tracking the interactions between a user and user interface elements (of data processing system 100).

To obtain user flow data sets for instance of a monitored workflow being performed, tracking system 102 may (i) obtain predefined parameters for various workflows to monitor (for data processing system 100), (ii) obtain data (eye tracking data, user input, etc.) from data processing system 100, (iii) identify occurrences of a monitored workflow performed by the user of data processing system 100, (iv) based on the identification and during performance of the monitored workflow, infer the attention of the user on user interface elements (presented to the user by data processing system 100) based on the eye tracking data and/or user input, (v) generate, based on the inferred attention of the user, a representation of the interactions between the user and the user interface elements that resulted in completion of the monitored workflow, (vi) provide the representation of the interactions to management system 104, and/or (vii) otherwise facilitate collection, transmission, and/or analysis of data usable for tracking the interactions between a user and user interface elements (of data processing system 100).

Management system 104 may include any number and/or types of device (e.g., data processing system, management systems, storage devices, user devices, etc.) that may provide computer implemented services, such as development services. To perform its functionality, management system 104 may (i) obtain user flow data (e.g., based on eye tracking data, user input, representation of interactions between a user and user interface elements) from tracking system 102, (ii) manage and/or provide access to the user flow data (e.g., to an authorized subject matter expert), (iii) provide updates (e.g., for the user interfaces) for operation of data processing system 100, (iv) establish best or desired workflows, (v) provide information regarding the best workflows to data processing system 100 for use in active monitoring of performed workflows, and/or (iv) otherwise participate in managing operation of data processing system 100.

Thus, the operation of data processing system 100 may be managed according to interactions between a user and user interface elements (presented by data processing system 100) resulting in completion of a workflow. The interactions may be based on inferred attention of the user using eye tracking data and user input during performance of the workflow. The tracked interactions for various workflows may be analyzed to identify a best possible set of interactions during performance of respective workflows and may be utilized to update and optimize the user interface (and/or user interface elements) to reduce unnecessary, repetitive steps (e.g., performed by the user) to complete the workflows. By doing so, a system in accordance with embodiment disclosed herein may provide data processing systems having, for example, (i) improved user experiences by minimizing unnecessary steps and/or slowdowns in completion of a workflow, and/or (ii) improved computing resource availability for desired computer implemented services.

Further, once identified, the best workflows may be used to guide users in future performance of workflows. For example, when the cognitive load of a user exceeds a threshold, data processing system 100 may infer a workload the user is attempting to perform, identify a next action in the workflow, and update user interfaces to provide the user with visual cues regarding how to perform the best workflow for the currently performed workflow by the user.

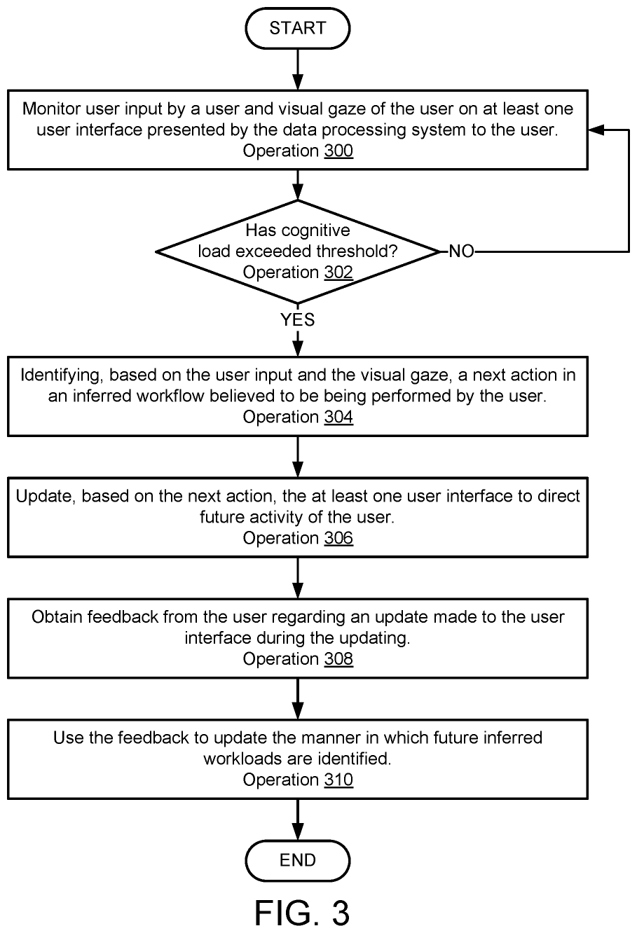

When providing its functionality, data processing system 100, tracking system 102, and/or management system 104 may perform all, or a portion, of the method and/or actions shown in FIG. 3.

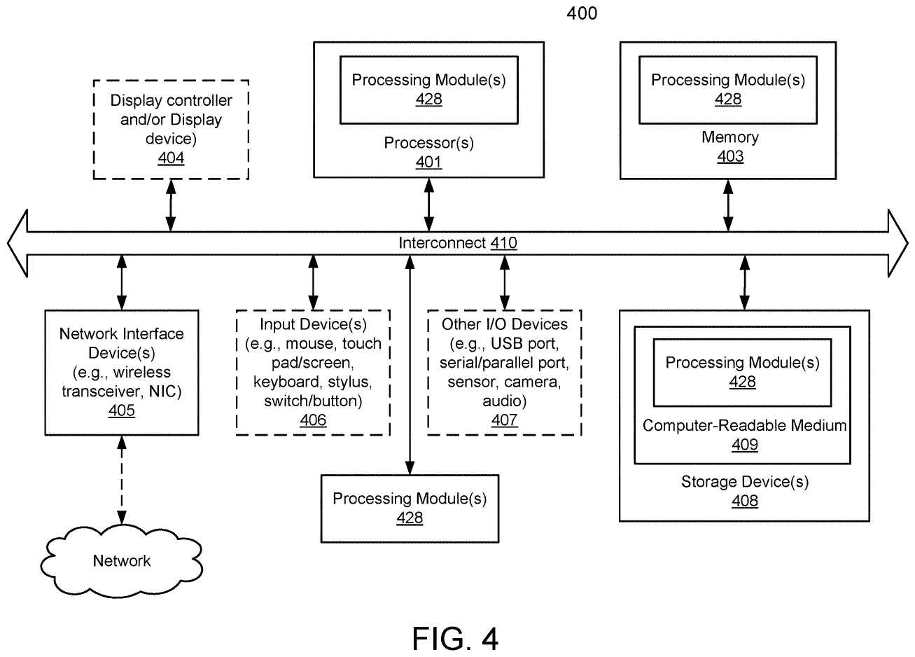

Any of (and/or components thereof) data processing system 100, tracking system 102, and/or management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

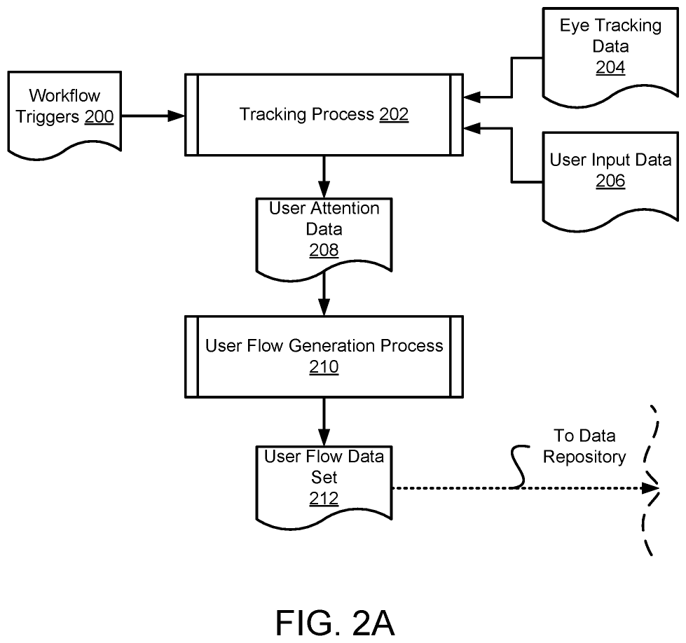

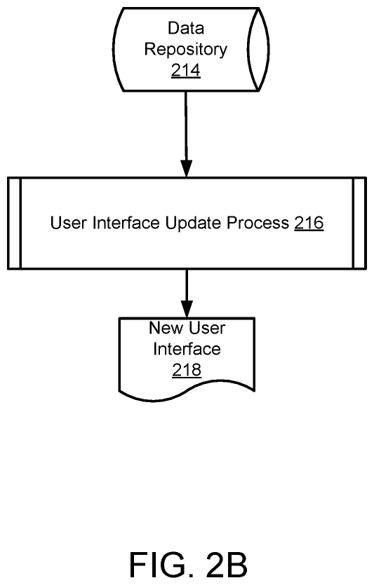

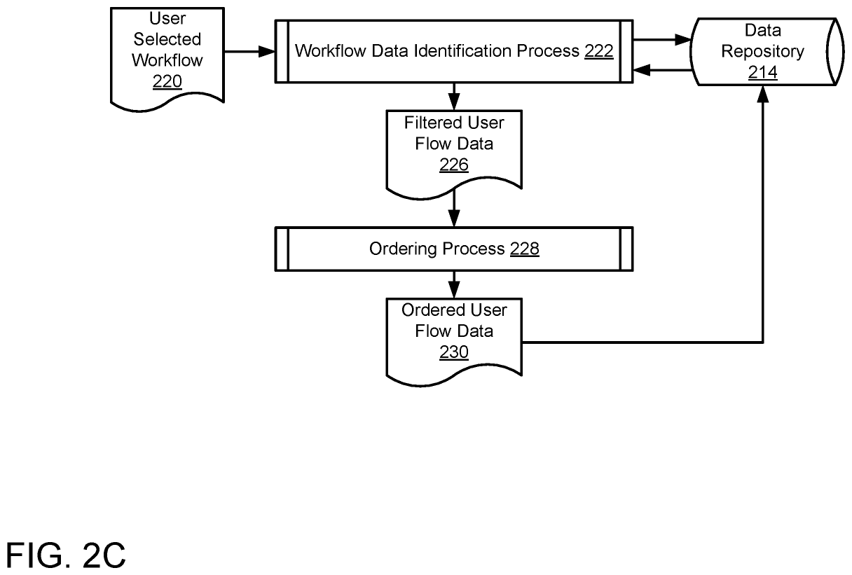

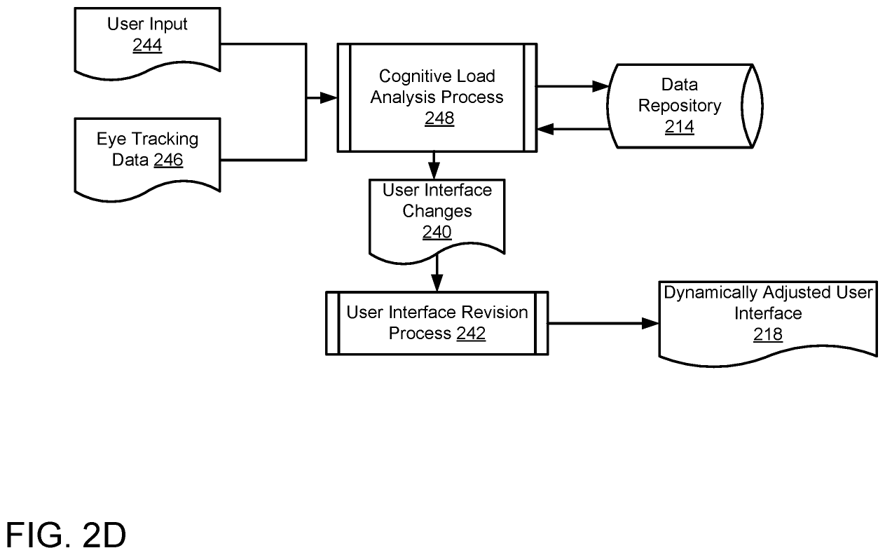

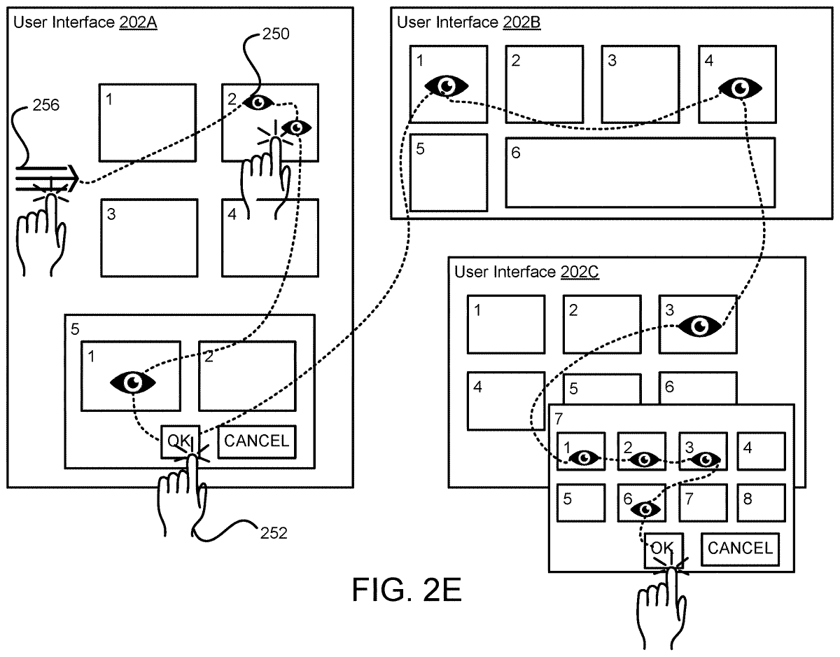

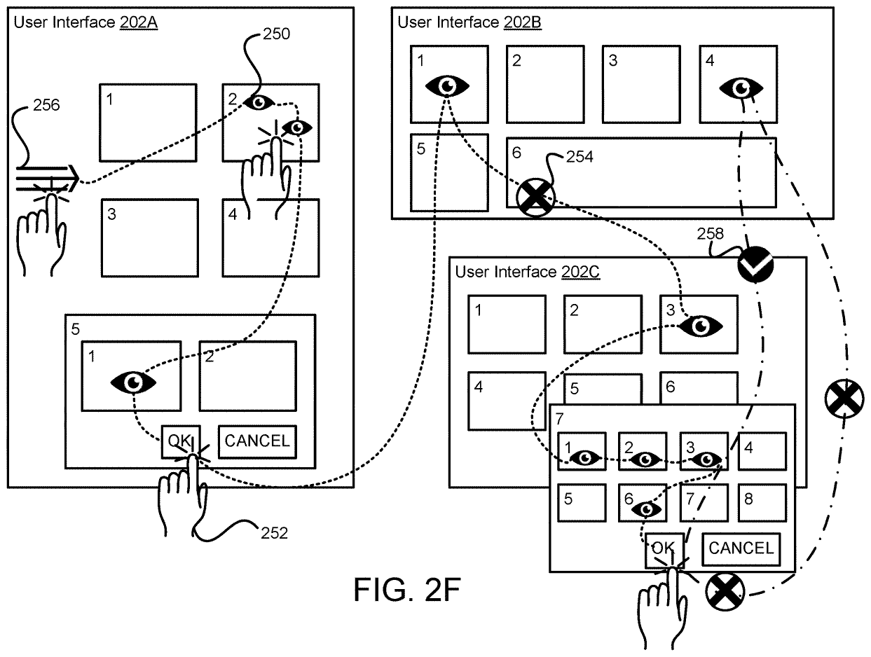

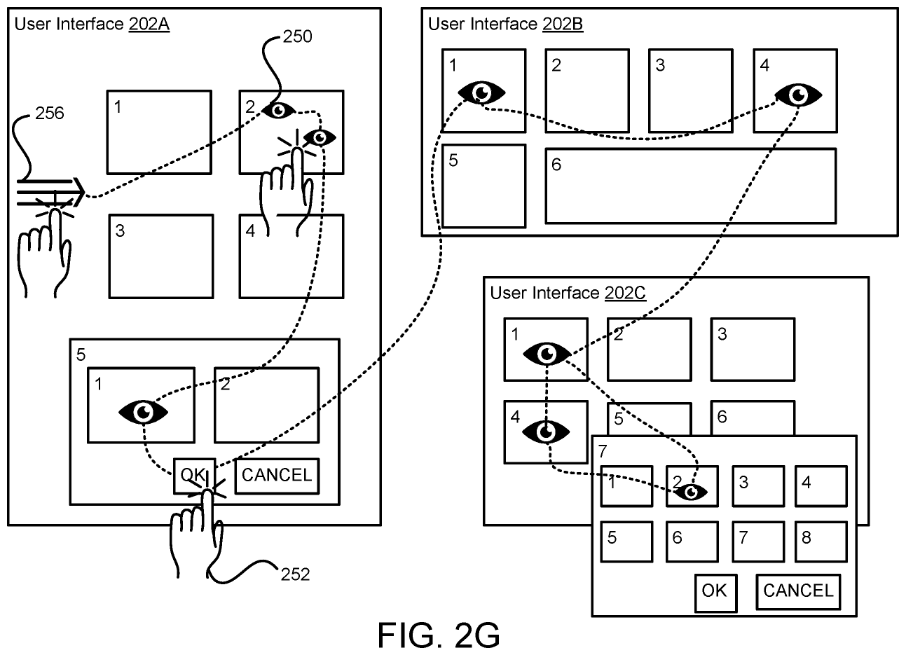

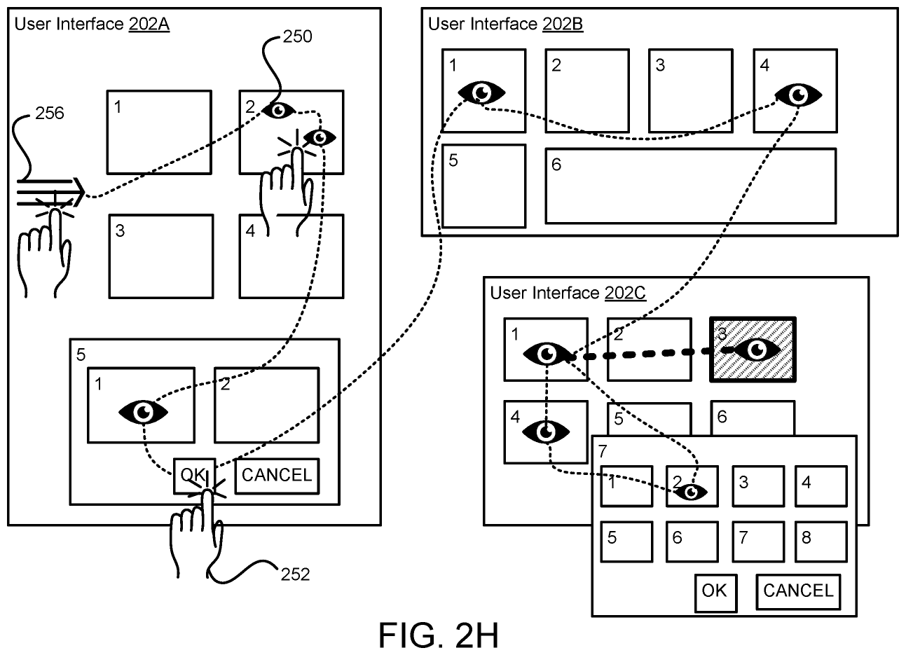

To further clarify embodiments disclosed herein, diagrams illustrating data flows implemented by a system over time in accordance with an embodiment are shown in FIGS. 2A-2D. In FIGS. 2A-2D, a first set of shapes (e.g., 204, 208) is used to represent data structures, and a second set of shapes (e.g., 202, 210) is used to represent processes performed using data, and a third set of shapes (e.g., 214) is used to represent large scale data structures such as databases.

Turning to FIG. 2A, a first data flow diagram illustrating data flows, data processing, and/or other operations that may be performed by the system of FIG. 1 in accordance with an embodiment is shown. The first data flow diagram may illustrate data used in and data processing performed in generating a representation of interactions between a user and user interface elements of a data processing system.

To generate a representation of the interactions between a user and user interface elements, eye tracking data 204 and user input data 206 may be obtained over a period of time (e.g., from data processing system 100). Eye tracking data 204 may include any type and/or quantity of data relating to a user's eye gaze on user interface elements (e.g., presented by the data processing system 100). For example, eye tracking data 204 may include information about where the user's gaze is focused on the screen (e.g., of data processing system 100).

User input data 206 may include any type of data representing physical actions such as, for example, pressing buttons, moving structures, etc. The physical actions of the user (e.g., operating data processing system 100) may be sensed by various devices and the sensing may be interpreted (e.g., translated) into the user input (e.g., user input data). For example, user input data 206 may include a user operating a keyboard, a mouse, and/or any other auxiliary device capable of receiving input signals from the user.

Tracking process 202 may collect and analyze eye tracking data 204 and user input data 206 during performance of various monitored workflows. Each monitored workflow (e.g., performed by a user of data processing system 100) may represent a user orientated task that has a defined start, a defined end, and that, when performed, results in a predetermined outcome.

To initiate tracking process 202, workflow triggers 200 may be identified. Workflow triggers 200 may include predefined parameters for monitored workflows, and may include trigger conditions for each monitored workflow indicating initiation and/or completion of the respective monitored workflow.

User input data 206 and/or eye tracking data 204 may be compared to workflow triggers 200 (trigger conditions associated with monitored workflows) to identify when any of the monitored workflows start. For example, a trigger condition for a monitored workflow may include identifying an instance of input signals received from selecting a widget (e.g., menu icon) via operation of a graphical user interface by a user. By identifying the selection of the widget (e.g., workflow trigger), the monitored workflow associated with the selection of the widget may be identified and thereby, initiate tracking process 202.

Once the occurrence of the monitored workflow has been identified, tracking process 202 may be performed to obtain user attention data 208 during performance of the monitored workflow. The attention of the user may be inferred based on eye tracking data 204, and/or user input data 206. Tracking process 202 may include collecting and/or analyzing eye tracking data 204 and user input data 206 during performance of the monitored workflow.

Eye tracking data 204 may be used to identify that a dwell of a gaze of the user on at least one of the user interface elements has exceeded a duration of time (e.g., predefined period of time set by a subject matter expert) and conclude that the attention of the user is focused on at least one of the user interface elements for the duration of time.

User input data 206 may be used to identify that the user has interacted with at least one of the user interface elements and conclude that the attention of the user is focused on the user interface elements for the duration of time (e.g., during which the user interacted with the user interface elements).

User attention data 208 may include any type and quantity of data representing inferred attention of the user, and may include a description of the user interface element for the interaction. For example, the user's attention on user interface elements (e.g., screens, view-blocks presented on different screens, etc.) may be inferred based on location of the user's eye gaze (e.g., from eye tracking data 204) and/or interactions of the user with the user interface elements (e.g., from user input data 206).

User attention data 208 for each monitored workflow may be obtained until the trigger condition indicating completion of the respective monitored workflow has been met. For example, for a monitored workflow, the trigger condition indicating completion of the monitored workflow may include terminating operation of a program, and if user input data 206 indicates selection of a closing out the program (e.g., via left click of a button on a computer mouse by a user) displayed via the graphical user interface, the trigger condition may be met and thereby conclude obtaining user attention data (208) for the monitored workflow.

User attention data 208 may be used in performing user flow generation process 210 to generate a representation of the interactions. During user flow generation process 210, the inferred attention of the user and interaction data may be processed to generate a user flow data set (e.g., user flow data set 212). A first string of data representing the user interface element and a second string of data representing the interaction (e.g., based on the inferred attention of the user during performance of the monitored workflow) may be concatenated into a third string (or a single data structure) representing a temporal order in which the interactions occurred.

To do so, for each user interface element (e.g., identified via user attention data 208), an interaction of the user with the user interface element may be identified and for each identified interaction, a label indicating the outcome of the interaction may be generated. For example, user input data 206 may be analyzed to append the status of the interaction (e.g., success or failure) between the user and the user interface element.

If the interaction between the user and the user interface element (e.g., program presented to the user via the graphical user interface) is accepted (e.g., a click on a button where the program accepts the user input and activates the next activity in the workflow), the interaction may be identified as a success. Conversely, if the interaction between the user and the user interface element is rejected (e.g., a click on the button where the program denies the user input and does not activate the next activity in the workflow), the interaction may be identified as a failure.

The interactions between the user and the user interface elements may provide data necessary to identify failures that occur around attempts to perform workflows. The interactions that are indicated as failures may provide guidance for eliminating and/or reducing the likelihood of potential failures to occur in the future.

The generated user flow data representing the interactions between the user and the user interface elements that resulted in completion of the monitored workflow is stored in a dataset (e.g., user flow data set 212). User flow data set 212 may be provided to any type of data repository for storage (e.g., accessible by tracking system 102, management system 104, etc.).

Thus, as shown in the example of FIG. 2A, a system in accordance with an embodiment may facilitate collection of tracking data (e.g., eye tracking data and user input) for a user interacting with user interface elements over a period of time, identifies user flows during the monitored workflows, and generates a representation of the user's interactions to further improve operation of the data processing system.

Turning to FIG. 2B, a second data flow diagram illustrating data flows, data processing, and/or other operations that may be performed by the system of FIG. 1 in accordance with an embodiment is shown. The second data flow diagram may illustrate data used in and data processing performed in utilizing data in preparation of obtaining a new user interface.

To utilize data in preparation of obtaining the new user interface, user flow data set 212 may be obtained and used in performance of various updating processes. User flow data set 212 may be stored in data repository 214 and accessible, for example, by management system 104. User flow data set 212 may include different types of user flow data sets obtained at different points in time by a tracking system (e.g., 102 shown in FIG. 1).

Based on a selected monitored workflow (e.g., by a user and/or administrator of data processing system 100), the associated user flow data set 212 may be obtained from data repository 214. The user flow data set for each performance of the selected monitored workflow may be utilized during performance of user interface update process 216 to determine modifications to the user interface to improve user experience and workflow efficiency. Refer to FIG. 2C for additional details regarding analyzation of user flow data and implementation of revisions to user interfaces.

As a result of performing user interface update process 216, a new user interface 218 may be obtained. New user interface 218 may include an updated user interface incorporating modifications and/or improvements to update operation data processing system 100 (e.g., as provided during user interface update process 216).

Thus, via the process illustrated in FIG. 2B, user flow data sets for a plurality of instances of performance of a monitored workflow may be used to update operation of a data processing system (e.g., update the user interface to obtain a new user interface).

Turning to FIG. 2C, a third data flow diagram illustrating data flows, data processing, and/or other operations that may be performed by the system of FIG. 1 in accordance with an embodiment is shown. The third data flow diagram may illustrate data used in and data processing performed during updating operation of a data processing system to obtain a new user interface and/or during dynamic reconfiguration of the operation of data processing systems (e.g., as discussed below with respect to FIG. 2D). The flows may be used, for example, during user interface update process 216 (e.g., shown in FIG. 2B).

To obtain a new user interface (e.g., new user interface 218), selected monitored workflow 220 may be obtained. Selected monitored workflow 220 may include any type and quantity of workflows that may be monitored and used in managing operation of the data processing system. Selected monitored workflow 220 may include a description of a user orientated task with a defined start, a defined end and that, when performed, results in a predetermined outcome.

Selected monitored workflow 220 may be obtained via (i) receiving user input from a device (e.g., user operating management system 104), (ii) identifying a management event has occurred (e.g., period of time has elapsed, user interface operation error, and/or any other type trigger condition) corresponding to the monitored workflow. For example, a user interface designer and/or another subject matter expert may provide user input (e.g., via operation of management system 104) indicating selection of a monitored workflow for which analysis and/or modifications may be of interest. The monitored workflow may also be obtained, for example, via an automated process. For example, the monitored workflow may be selected based on a time schedule (e.g., defining a specific times and/or duration of times to elapse) and therefore, automatically initiating the selection of the monitored workflow.

Based on the selected monitored workflow, workflow data identification process 222 may be performed. During workflow data identification process 222, the selected monitored workflow may be used in querying data repository 214 to obtain relevant data related to the selected monitored workflow. For example, an identifier for the monitored workflow may be used to perform a look up to identify user flow data sets associated with the monitored workflow.

As a result of performing workflow data identification process 222, filtered user flow data 226 may be obtained. Filtered user flow data 226 may include any filtered data retrieved from data repository 214 that includes relevant information about the monitored workflow. Filtered user flow data 226 may include each recorded user flow data set for the monitored workflow. For example, for each performance of the monitored workflow (e.g., by users), a user flow data set (e.g., indicating a set of interactions initiated by a user during a corresponding instance of the performance of the monitored workflow) may be obtained. Filtered user flow data 226 may include any type and/or quantity of user flow data sets for each instance of the monitored workflow being performed.

Filtered user flow data 226 may be used in ordering process 228 to obtain an ordering of the user flow data sets for each instance of the monitored workflow being performed.

During ordering process 228, filtered user flow data 226 may be analyzed to obtain metadata usable to perform an ordering of the filtered user flow data to obtain ordered user flow data 230. For example, the user flow data sets may be used in any type of analyzation process to identify content (e.g., metadata) of the user flow data sets contributing to duration of time and probabilities of failures (e.g., undesired outcomes for each interaction) occurring.

For example, the user flow data sets may be analyzed to identify (i) an interaction count (e.g., number of interactions that the user performed to complete a corresponding instance of the monitored workflow), (ii) for each interaction, a transition cost for transitioning between two of the interactions, (iii) for each interaction, a type of the interaction, (iv) for each interaction, indication of whether the interaction lead to a desired outcome for the user, and/or other information usable to order the user flow data sets. To do so, the quantifications from filtered user flow data 226 may be compared to predetermined quantifications (e.g., defined by subject matter experts, automated analysis such as machine learning/data mining) associated with interactions performed in a prescribed manner.

Once obtained, the metadata (and/or a portion of the metadata) may be used to estimate a user time cost corresponding to the respective user flow data set. The user time cost may include an estimated duration of time for completing a corresponding user flow data set of the user flow data sets when performed in a prescribed manner by the user.

During ordering process 228, the metadata and the user flow data sets may be used in any type of optimization process to obtain an ordering of the user flow data sets. The optimization process may include using any type of function that weighs different quantifications (e.g., portions of the metadata) to obtain a weighted sum for each user flow data set. The weighted sum may be ascribed to each user flow data set and used to rank order the user flow data sets to identify the most optimal series of interactions (e.g., user flow data set with the lowest user time cost).

For example, ordering the user flow data sets may include comparing the user time costs for each user flow data sets to obtain a ranking order of the user flow data set with the lowest user time cost as the highest ranked user flow data set and the highest user time cost as the lowest ranked user flow data set.

The resulting ordered user flow data 230 from ordering process 228 may indicate (i) user flow data sets with the shortest duration of time for completing the monitored workflow and most likely to lead to a desired outcome for the user, (ii) user flow data sets with the longest duration of time for completing the monitored workflow and most likely to lead to undesired outcomes (e.g., failures) for the user, etc. In other words, ordered with respect to a particular goal, aspect, etc. Once obtained, ordered user flow data 230 may be stored in data repository 214 for use in both (i) user interface revision and (ii) dynamic adjustment of operation of data processing systems during performance of workflows.

For example, to decide how to update user interface, ordered user flow data 230 may be used in a visualization process to generate a visual representation of the interactions between the user and user interface elements during performance of each workflow.

The visualization process may include generating a visual representation of the user's interactions with each workflow performed. The visual representation may be presented, for example, to a developer (via operation of management system 104) to illustrate how users are interacting with user interface elements to complete various workflows.

As part of the visualization process, user input may be obtained, for example, by the developer and/or subject matter expert (e.g., operating management system 104 and/or graphical user interface hosted by management system 104). The user input may include any recommendations or suggestions for modifications to the user interface based on the visual representation of the interactions during performance of the workflows. For example, the user input may include input on potential changes to the user interface based on informed insights impacting the current user interface design, such as identified bottlenecks or inefficiencies.

For example, the developer may identify that users are struggling to find and click on a specific button (e.g., the “submit” button is too small and buried at the bottom of a form) within a web application, which is essential for completing the selected workflow. The user input may include a recommendation to increase the size of the “submit” button, move the “submit” button to the top of the form, and/or any other modifications that may improve the user's ability to easily see the “submit” button.

Corresponding new user interfaces based on the visualizations may be developed and deployed to data processing systems. However, some users may still have difficulty navigating the new user interfaces. To address such challenges, the data processing systems may dynamically update their operation based on the ordered user flow data to help guide users through performance of workflows.

Turning to FIG. 2D, a fourth data flow diagram illustrating data flows, data processing, and/or other operations that may be performed by the system of FIG. 1 in accordance with an embodiment is shown. The fourth data flow diagram may illustrate data used in and data processing performed to dynamically reconfigure operation of data processing systems.

To dynamically reconfigure operation of a data processing system, cognitive load analysis process may be performed. During cognitive load analysis process, user input 244 and eye tracking data 246 may be obtained as a user uses at least one user interface presented by the data processing system. User input data 244 and eye tracking data 246 may be analyzed to identify a cognitive load on the user. The cognitive load may be analyzed by (i) using user input 244 and eye tracking data 246 to infer attention of the user with respect to the user interface, (ii) identify a gaze path (e.g., an attention path) of the user with respect to the at least one user interface, (iii) review the gaze path for loops (e.g., going between two interface elements in a circular path), reversions (e.g., going backward along an already traversed gaze path), extended dwells (e.g., focusing on an interface element for beyond a threshold duration of time), excursions outside of the user interfaces, and/or other indicators that the user may not be able to follow a workflow, (iv) grade the identified indicators from the gaze path (e.g., using a scoring system), (v) identify a level of the cognitive load based on the grade (e.g., different load levels may have different grade ranges), etc.

If the level of cognitive load exceeds a threshold level (or meets other criteria), then user input 244 and eye tracking data 246 may be analyzed to infer a likely workflow being performed by the user. For example, new user flow data based on user input 244 and eye tracking data 246 may be obtained. The new user flow data may then be compared to user flow data from data repository 214 corresponding to the monitored workflows to identify a closest user flow data from data repository. The monitored workflow associated with the closest user flow data may be used as the inferred workflow being performed by the user.

Based on the identification, the closest user flow data may be compared to the new user flow data to identify a likely next action of the user in the inferred workflow. Because the likely next action is with respect to an interface element indicated by the closest user flow, the corresponding user interface element in the user interface presented to the user may be identified.

To draw the users attention to the corresponding user interface element, the graphical user interface may be updated by, for example, making the corresponding user interface element to change color, be highlighted, and/or otherwise modified to visually draw the user's attention to it. While described with respect to visual feedback, audio (e.g., beeps) feedback, tactile feedback, and/or other types of user feedback may be provided to the user to attempt to draw the user's attention. These changes may be stored as user interface changes 240 and used in user interface revision process 242.

During user interface revision process 242, the changes to the graphical user interface indicated by user interface changes 240 may be applied resulting in the creation of dynamically adjusted user interface 218. The changes may be temporary and may be reverted at a future point in time.

Once the new user interface is presented to the user, a user's response to the dynamically adjusted user interface may be tracked and used as feedback in the comparing process. For example, if the user uses the emphasized user interface element, then positive feedback may be recorded and used to reinforce the match between the new user flow and the matched user flow (e.g., weights in similarity analysis used during the comparing may be adjusted to make it more likely that similar matches will occur in the future). In contrast, if the user does not user the emphasized user interface element or otherwise indicates that the change in user interface is not helpful, then negative feedback may be recorded and used to make the match between the new user flow and the matched user flow less likely to occur in the future (e.g., weights in similarity analysis used during the comparing may be adjusted to make it less likely that similar matches will occur in the future).

If the dynamic changes do not resolve the elevated cognitive load on the user, then the flow may return to cognitive load analysis process 248, where the activity of the user (e.g., user input, eye tracking data) may be reevaluated to attempt to identify other workflows that they user may be attempting to perform.

Turning to FIG. 2E, a first example illustration of interactions between a user and user interface elements (presented by a data processing system) during performance of a monitored workflow in accordance with an embodiment is shown.

In FIG. 2E, various symbols (e.g., 250, 252, 256, etc.) are used to indicate interactions with a user interface by a user. For example, the symbols may include a first illustrative symbol 252, which represents using a pointing device to click on a graphical user interface element. For example, a user may operate a computer mouse to navigate the pointing device (e.g., cursor) displayed on the user interface element and provide user input (e.g., user input data 206 shown in FIG. 2A).

As an additional example, a second illustrative symbol may indicate a user's gaze has been directed at a portion of the user interface for a duration of time (e.g., exceeding a threshold) that we conclude that the user's attention is directed to that user interface element. In addition, a third illustrative symbol 256 may represent a menu icon (widget displayed on user interface element 202A).

As described above, to identify when any of monitored workflows start, eye tracking data and/or user input may be compared to trigger conditions associated with monitored workflows. The user may select the menu icon (e.g., trigger condition) to initiate a monitored workflow. The monitored workflow may include navigating a first program (e.g., user interface element 202A) by visually reviewing function 2.0 and 2.1, activating function 2 (e.g., via user input), visually reviewing function 5.1, and selecting the “OK” button (e.g., indicated by click).

The monitored workflow may continue with operation of a second program (e.g., user interface 202B), by visually reviewing function 1 and function 4 (e.g., illustrated by second illustrative symbol). After which, the user may continue the monitored workflow via operation of a third program (e.g., user interface 202C) by visually reviewing function 3, function 7.1, 7.2, 7.3, 7.6, and selecting “OK” to complete the monitored workflow.

By generating a logical attention map during performance of a workflow using eye tracking data and user input, the attention of the user may be inferred. The inferred attention of the user may be used to identify an interaction of the user with the user interface elements and generate a first string representing the user interface element and a second string representing the interaction. The second string may uniquely identify the interaction and/or an outcome of the interaction. The first string and the second string may be concatenated (e.g., combined) to obtain a third string representing the interactions of the user with the user interface elements corresponding to a temporal order in which the interactions occurred.

The representation of interactions between the user and the user interface elements may be used to update operation of data processing system 100. For example, a user experience designer may use the information to reconfigure the design of an application. The improvements in downstream use (e.g., usability) may allow for improved remediation of future failures of data processing systems, thereby improving the reliability and/or accessibility to computer-implemented services provided by the data processing systems.

Turning to FIG. 2F, a second example illustration of interactions between a user and user interface elements (presented by a data processing system) during performance of a monitored workflow in accordance with an embodiment is shown. The monitored workflow illustrated in FIG. 2F may be similar (but may include different actions of the user) to the monitored workflow performed in FIG. 2E.

In FIG. 2F, user interface elements (e.g., 202A, 202B, 202C) may be similar to the user interface elements shown in FIG. 2E and various symbols (e.g., 250, 252, 256, etc.) used to indicate interactions with a user interface by a user may be similar to those illustrated and described above in FIG. 2E. For example, the symbols may include a first illustrative symbol 252, which represents using a pointing device to click on a graphical user interface element. For example, a user may operate a computer mouse to navigate the pointing device (e.g., cursor) displayed on the user interface element and provide user input (e.g., user input data 206 shown in FIG. 2A).

In addition, the illustrative symbols (e.g., 254 and/or 258) may indicate an outcome of the interaction (e.g., whether the interaction lead to a desired outcome for the user). For example, illustrative symbol 254 may represent a failure regarding the outcome of the interaction (e.g., determination that the interaction lead to an undesired outcome for the user). The undesired outcome may indicate, for example, a failure to perform a function as intended by the user and therefore hindering the ability of the user to perform the next interaction that leads to (and/or eventually leads to) completion of the monitored workflow.

For example, the line drawn in dashing between the interaction of the user's gaze (e.g., indicated by the interaction 250 at user interface 202B) at function 1 and the user's gaze at function 3 of user interface 202C may indicate the visual pathway travelled by the eye's of the user. The pathway between the interactions may be labelled as a failed outcome (e.g., illustrated by 254) as a result of the interactions lead to an undesired outcome for the user (e.g., failing to perform a function to move to the next interaction, not providing necessary information to reach the defined end of the monitored workflow, etc.).

The illustrative symbol 258 may represent a success regarding the outcome of the interaction (e.g., determination that the interaction lead to a desired outcome for the user). The desired outcome may indicate, for example, a success to perform a function as intended by the user and therefore allowing the user to perform the next interaction that leads to (and/or eventually leads to) completion of the monitored workflow.

For example, the line drawn in a dash separated by a dot illustrated between the interaction of the user input (e.g., 252 selecting “OK”) and the user's gaze at function 4 of user interface 202B may indicate the pathway travelled between the two interactions. The pathway between the interactions may be labelled as a successful outcome (e.g., illustrated by 258) as a result of the interactions leading to a desired outcome for the user (e.g., successfully performing a function to move to the next interaction, providing the necessary information to reach the defined end of the monitored workflow, etc.).

To obtain metadata for the user flow data set (e.g., series of interactions shown in FIG. 2F) may include analyzing each interaction of the set of interactions. For example, each interaction may be counted and for each counted interaction, the type of interaction (e.g., user input, eye gaze, etc.), the transition cost between the two interactions, identifying whether the interaction lead to a desired outcome of the interaction, and/or any other information may be identified and used to generate an estimated duration of time to complete the monitored workflow.

To obtain clear quantifications of how users interaction with user interface elements during performance on a monitored workflow, a standardized method of scoring each user flow data set may be implemented by using predefined estimates for each quantification that contributes to the performance of the monitored workflow. The predefined estimates for each quantification may be established, for example, by a subject matter expert. For example, time estimates to each user interaction may be assigned based on predefined expert evaluations (e.g., 0.5 seconds, 1.5 seconds, etc.), to measure user time cost. Different types of user interactions (e.g., eye movements, mouse clicks, etc.) may have distinct expect time costs, where certain actions (e.g., like eye movements) might be faster.

The transition cost between two interactions (e.g., interaction 1 and 2) may include measuring the time it takes to move between different interactions, influenced by the distance between the view blocks (e.g., different user interface elements) during performance of the monitored workflow in a prescribed manner by the user. For example, the transition cost between interaction 1 and interaction 2 may be estimated by performing a function that identifies a weight to the time elapsed between the interactions.

By obtaining the metadata for the user flow data set, the user flow data set may be compared to other user flow data sets for other instances of performing the monitored workflow in order to obtain an ordering of the user flow data sets. The user flow data set represented in FIG. 2F may be compared to the user flow data set represented in FIG. 2E and the outcome may indicate the user flow data set shown in FIG. 2E has a lower user time cost (e.g., lower weighted sum) than the user flow data set shown in FIG. 2F. As a result, the metadata indicating quantifications impacting the user time cost may be analyzed to identify modifications and/or updates to the user interface elements that may be implemented for improving user interactions. Thereby, improving the likelihood of performing the monitored workflow in a desired manner and the computer implemented services being provided may be increased.

Turning to FIGS. 2G-2H, second and third example illustrations of interactions between a user and user interface elements (presented by a data processing system) during performance of a monitored workflow in accordance with an embodiment are shown.

As discussed above with respect to FIG. 2D, the system of FIG. 1 may actively monitoring cognitive load levels on user attempt to perform workflows, and proactively and automatically intervene to assist the user in performance of the workflows.

Now, consider an example scenario illustrated in FIG. 2G where a user attempts to perform a workflow similar to that illustrated in FIG. 2E. However, in contrast to the instance of the performance of the workflow shown in FIG. 2E, after the user completes the portions of the workflow associated with user interface 202B, the user becomes confused about the next steps in the workflow. Consequently, when the user's attention changes to user interface 202C in this example, the user does not identify that the next step in the workflow requires the user to focus on interface element number three of user interface 202C. As seen in FIG. 2G, for example, the user's attention may drift between interface elements one and four of user interface 202C and then user interface element two of sub menu seven, and then may return to interface element one of user interface 202C. Based on this pattern of the user's attention, the system may automatically quantify the cognitive load on the user as exceeding a threshold level of cognitive load (e.g., attention loops without user input may be scored sufficiently high to meet the threshold level).

Turning to FIG. 2H, based on the identification that the user's cognitive load has exceeded the threshold, the system may automatically intervene. To intervene, the system may (i) infer a workflow being performed by the user, (ii) review the corresponding user flow data to identify a next activity in the workflow (e.g., in this case, interacting with the third interface element of user interface 202C), and (iii) dynamically update user interface 202C to draw the user's attention. In this example, the dynamic update to user interface 202C is illustrated by adding striped infill to the third user interface element of user interface 202C. Of course, the specific change may be any type of change (e.g., change in color, outlining, highlighting, size, shape, etc.) that may draw the user's attention.

In addition to graphical changes, the system may also provide sensory cues using other modalities such as, for example, playing sounds, providing tactile feedback (e.g., vibration), etc. These multisensory cues, in combination with the visual changes, may help the user reduce cognitive load by (i) identifying that assistance is available, and (ii) looking for visual assistance based on changes to user interfaces.

In this example, after the visual cues and multisensory cues are initiated, the user is able to identify that the third interface element may be part of the next action in the workflow. Accordingly, the user's attention may be drawn to it (e.g., in FIG. 2H, the gaze path illustrated using dashed line with higher line weight indicates the portion of the gaze path induced by the feedback).

As discussed above, the components of FIGS. 1-2E may perform various methods to manage operation of data processing systems. FIG. 3 illustrates a method that may be performed by the components of the system of FIGS. 1-2E. In the diagram discussed below and shown in FIG. 3, any of the operations may be repeated, performed in different orders, and/or performed in parallel with or in a partially overlapping in a timely manner with other operations. The method described with respect to FIG. 3 may be performed by a data processing system and/or another device of the system of FIG. 1.

Turning to FIG. 3, a flow diagram illustrating a method of dynamically managing operation of a data processing system in accordance with an embodiment is shown.

At operation 300, user input by a user and visual gaze of the user on at least one user interface is presented by the data processing system to the user is monitored. Through the monitoring, any number of interactions between the user and the user interfaces may be identified.

At operation 302, a determination is made regarding whether a cognitive load on the user has exceeded a threshold level of cognitive load. The determination may be made by (i) estimating the level of cognitive load based on the user input and visual gaze of the user over time, and (ii) comparing the estimate to the threshold level.

The level of cognitive load may be estimated by identifying aspects of the visual gaze path that indicate that the user is unable to identify next steps in a workflow. For example, the visual gaze path may be reviewed over time to identify presence of (i) loops (e.g., returning to previously gazed upon interface elements), (ii) reversions (e.g., returning to previously gazed upon user interfaces), (iii) extended dwells (e.g., gaze staying in a certain location for durations of time that exceed thresholds, (iv) excursions (e.g., gaze of the user leaving a display, leaving a set of user interfaces, etc.), and/or other identifiable features of the gaze path that may indicate that the user is unable to make forward progress on performance of a workflow. Each of such aspects of the gaze path may be scored using a scoring system to obtain a score for the user, which may be treated as the cognitive load level.

If the cognitive load of the user has exceeded the threshold, then the method may proceed to operation 304. Otherwise the method may return to operation 302.

At operation 304, a next action in an inferred workflow believe to be performed by the user may be identified based on the user input and the visual gaze. The inferred workflow may be identified by (i) establishing new user flow data based on the user input and the visual gaze, and (ii) performing a similarity analysis or other matching process to existing user flow data for previously monitored workflows (e.g., that are deemed best workflows) to identify one of the monitored workflows. The identified monitored workflow may be the inferred workflow.

During the similarity analysis, portions of the new user flow data that indicate that the cognitive load on the user exceeded the threshold may be excluded. In other words, activity of the user that is likely not part of a best workflow may be excluded from the similarity analysis. The similarity analysis may be any type of analysis, and may use, for example, inference models to match the new user flow to one of the monitored workflows. As will be discussed below, the inference models may be updated over time using, for example, reinforced learning or other techniques to improve future matching processes. For example, if the inferred flow turns out to not be the workflow that the user is performing, the inference model may be updated (e.g., weight modification, retraining, etc.) to be less likely to make similar matches in the future. In contrast, if the inferred flow turns out to be the workflow that the user is performing, then the inference model may be updated to be more likely to make similar matches in the future.

To do so, the system may monitor the future activity of the user (e.g., by eye tracking and user input tracking), making an identification regarding whether the future activity indicates that the inferred workflow is an actual workflow being performed by the user (e.g., do the future performed activities match subsequent actions in the inferred flow or not, in other words implicit feedback on accuracy of the inferred workflow), and using the identification to update that manner in which future inferred workloads are identified (e.g., by updating weights, retraining, etc.). In addition to the implicit feedback, the system may solicit or obtain explicit feedback from the user, and use the explicit feedback to update the manner in which future inferred workloads are identified. For example, the user may provide user input or may not follow cues provided by the system. This explicit feedback may also be used to update the similarity analysis performed in the future to improve match quality.

The next action may be identified by identifying actions of the inferred workflow that the user has already performed, and a next action in the inferred workflow that has not been performed. The not yet performed next action may be selected as an action that the user should perform next to work towards completion of the inferred workflow.

At operation 306, the at least one user interface is updated based on the next action to direct future activity of the user. The at least one user interface may be updated by (i) modifying existing user interface elements to direct the user's attention to them, (ii) add graphical elements (e.g., lines between cursor/gaze locations and user interface elements), and/or otherwise modifying the at least one user interface. Additionally, multisensory cues may also be added to further enhance the direction provided to the user.

Based on the updates, the user may or may not perform the next action, but if the next action is performed the cognitive load on the user may be reduced (e.g., by resolving tension of the user). Accordingly, the user may be guided toward completion of the workflow.

At operation 308, feedback from the user regarding an update made to the user interface during the updating may be obtained. The feedback may be obtained by monitoring user input and/or gaze of the user while the updated user interface is presented to the user. In other words, the user may provide explicit feedback.

At operation 310, the feedback is used to update the manner in which future inferred workloads are identified. The feedback may be used, for example, by modifying weights or other aspects of data used in similarity analysis. If the explicit feedback, the feedback may be used to increase the likelihood of similar matches being made in the future. If the explicit feedback is negative, then the feedback may be used to decrease the likelihood of similar matches being made in the future.

The method may end following operation 310.

It will be appreciated that the flow shown in FIG. 3 may be continuously performed while a user is using user interfaces provided by data processing systems, or discontinuously (e.g., users may control when such flows are performed based on preferences).

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
monitoring user input by a user and visual gaze of the user on at least one user interface presented by the data processing system to the user;
in an instance of the monitoring where the user input and/or the visual gaze indicates that a level of cognitive load on the user has exceeded a threshold level:
identifying, based on the user input and the visual gaze, a next action in an inferred workflow believed to be being performed by the user; and
updating, based on the next action, the at least one user interface to direct future activity of the user.

2. The method of claim 1, further comprising:
identifying, based on the user input and the visual gaze, the inferred workflow from a plurality of inferred workflows.

3. The method of claim 2, wherein each of the plurality of inferred workflows are based on attention of a user during previous performances of the inferred workflows.

4. The method of claim 3, wherein the attention of the user is based on, at least, second user input by the user and second visual gaze of the user during the previous performances of the inferred workflows.

5. The method of claim 4, wherein each of the inferred workflows is an instance of previously performance instances of a monitored workflow that is deemed to be a best workflow.

6. The method of claim 5, wherein the best workflow is a shortest workflow.

7. The method of claim 1, further comprising:
obtaining feedback from the user regarding an update made to the user interface during the updating; and
using the feedback to update a manner in which future inferred workloads are identified.

8. The method of claim 1, further comprising:
estimating the level of cognitive load based on loops, reversions, and/or other aspects of a visual gaze path indicated by the visual gaze over time.

9. The method of claim 1, further comprising:
monitoring the future activity of the user;
making an identification regarding whether the future activity indicates that the inferred workflow is an actual workflow being performed by the user; and
using the identification to update a manner in which future inferred workloads are identified.

10. The method of claim 1, wherein the inferred workflow is a remediation workflow for resolving a root cause of an issue impacting operation of the data processing system.

11. A non-transitory machine-readable medium having instructions stored therein, which when executed by a processor, cause the processor to perform operations for managing operation of a data processing system, the operations comprising:
monitoring user input by a user and visual gaze of the user on at least one user interface presented by the data processing system to the user;
in an instance of the monitoring where the user input and/or the visual gaze indicates that a level of cognitive load on the user has exceeded a threshold level:
identifying, based on the user input and the visual gaze, a next action in an inferred workflow believed to be being performed by the user; and
updating, based on the next action, the at least one user interface to direct future activity of the user.

12. The non-transitory machine-readable medium of claim 11, wherein the operations further comprise:
identifying, based on the user input and the visual gaze, the inferred workflow from a plurality of inferred workflows.

13. The non-transitory machine-readable medium of claim 12, wherein each of the plurality of inferred workflows are based on attention of a user during previous performances of the inferred workflows.

14. The non-transitory machine-readable medium of claim 13, wherein the attention of the user is based on, at least, second user input by the user and second visual gaze of the user during the previous performances of the inferred workflows.

15. The non-transitory machine-readable medium of claim 14, wherein each of the inferred workflows is an instance of previously performance instances of a monitored workflow that is deemed to be a best workflow.

16. A data processing system, comprising:
a processor; and
a memory coupled to the processor to store instructions, which when executed by the processor, cause the processor to perform operations for managing operation of the data processing system, the operations comprising:
monitoring user input by a user and visual gaze of the user on at least one user interface presented by the data processing system to the user;
in an instance of the monitoring where the user input and/or the visual gaze indicates that a level of cognitive load on the user has exceeded a threshold level:
identifying, based on the user input and the visual gaze, a next action in an inferred workflow believed to be being performed by the user; and
updating, based on the next action, the at least one user interface to direct future activity of the user.

17. The data processing system of claim 16, wherein the operations further comprise:
identifying, based on the user input and the visual gaze, the inferred workflow from a plurality of inferred workflows.

18. The data processing system of claim 17, wherein each of the plurality of inferred workflows are based on attention of a user during previous performances of the inferred workflows.

19. The data processing system of claim 18, wherein the attention of the user is based on, at least, second user input by the user and second visual gaze of the user during the previous performances of the inferred workflows.

20. The data processing system of claim 19, wherein each of the inferred workflows is an instance of previously performance instances of a monitored workflow that is deemed to be a best workflow.
